(19) United States
(12) Patent Application Publication
(10) Pub. No.: US 2008/0306662 A1
(43) Pub. Date: Dec. 11, 2008

(54) OPERATING DEVICE FOR AT LEAST TWO FUNCTIONS OF A FLOOR CONVEYOR

(76) Inventor: Jan Herschel, Bad Oldesloe (DE)

Correspondence Address: Hiscock & Barclay, LLP, One Park Place, 300 South State Street, Syracuse, NY, 13202-2078, US

(21) Appl. No.: 12/134,593

(22) Filed: Jun. 6, 2008

(30) Foreign Application Priority Data
Jun. 6, 2007 (DE) 20 2007 007 951.6

(51) Int. Cl. G06F 19/00

(52) U.S. Cl. 701/50

(57) ABSTRACT

Operating device for at least two functions of a floor conveyor, featuring at least one manually operable operational control element for an electric switch, which is connected with an electric/electronic control unit for the functions via electric lines. A plug- in codification connection is arranged in the course of the wiring of the leads, the interior connection of which pre-sets which one of the two functions are driven by the operational control element. An indicating panel for the respective envisioned function is arranged on a visible surface in the floor conveyor near to the operational control element, in which a sign or a carrier for an indicating panel is non-detachably connected with the plug-in codification connection.

### FIELD OF THE INVENTION

The present invention is related to an operating device for at least two functions of a floor conveyor.

### BACKGROUND OF THE INVENTION

As is well known, a floor conveyor does not only need a steering device and an actuation element for the travelling drive, but also at least one operational control element for the actuation of a load pick-up means, of a load fork for instance. In the simplest case, the load fork is lifted, in fact either in the free lift or even to a greater height, depending on the type of the vehicle. Furthermore, it is known to tilt the load fork or to push it forward or backward, respectively, namely with or without the lifting scaffold. Manually operable operational control elements are correspondingly provided for the individual functions, which are arranged within the reach and the eyespot of the driver of the floor conveyor. It is also known to accommodate plural operating functions in one common handle, at a so-called multipilot for instance.

Switches are assigned to the individual operational control elements, which are actuated by the operational control elements and thus generate a signal for a control unit, by which the individual functions are activated. It is also known to actuate different functions by one operational control element at option. In this case, it only depends on the hardware side wiring, whether an operational control element is used for lifting or lowering a load fork or for lateral shifting, for instance. For this purpose, a plug-in codification connection is arranged between the switch which is assigned to the operational control element and the control unit, Depending on the interior wiring of the plug-in codification connection, the operational control element is assigned to a particular function. When an installation or servicing person wants to envision the assignment of the operational control element to another function, he/she has to replace the plug-in codification connection by another one. For this sake, a so-called codification plug is usually envisioned, which is provided with a female and a male connector unit, so that the same can be used in the course of the wiring of the line connection. In doing so, the installation or servicing person has to take care that the proper indication occurs in the indicating panel which is assigned to the respective operational control element, so that the operator of the floor conveyor is informed about the correct assignment of the operational control element to the function which is switched on. Inadvertence at installation or servicing works can have the result that a wrong function for an operational control element is indicated to the driver or operator, respectively, of the floor conveyor.

### SUMMARY OF THE INVENTION

Thus, the present invention is based on the objective to provide an operating device for at least two functions of a floor conveyor in which it is made sure that the correct respective function assignment of the respective operational control element is indicated to the operator of a floor conveyor.

In the invention, a sign or a carrier for an indicating panel is non-detachably connected with the plug-in codification connection via a connection means.

In the new assembly, the plug-in codification connection is connected with the indicating panel from on the beginning, so that the correct indicating panel is shown to the operator of the floor conveyor automatically, when the plug-in codification connection is built in. In the case of a replacement, the plug-in codification connection is removed together with the indicating panel. Any separation of the indicating panel from the plug-in codification connection can take place only by destruction of the non-detachable connection. Yet, this is a sufficient advice for the installation person, to remove the indicating panel also when the plug-in codification connection is removed.

According to one embodiment of the invention, the connection means is a ribbon, preferably a flat ribbon. The flat ribbon has the advantage that it can be guided through a very narrow gap or slit in the field of vision of the driver to the region below the field of vision, which is formed by a corresponding planking in the floor conveyor.

According to another embodiment of the invention, the plug-in codification connection is arranged on a casing, which is non arranged in an opening of the visible surface and which has the indicating panel on its outer side. The casing can be arranged via a catching connection in the opening, for instance. When the casing is removed from the opening, the indicating panel is removed together with it at the same time. The casing contains a so-called codification plug with a pre-set wiring of the female and the male connectors.

Alternatively, the carrier for the indicating panel may be a plate made of plastic material, which is attached on the visible surface in a suitable manner, by gluing for instance, or even by catching it in an opening. The indicating panel may be immediately engraved into the plate or it may be adhered to the plate in the form of a sheeting by gluing.

### BRIEF DESCRIPTION OF THE DRAWINGS

In the following, the present invention is explained in more details by means of drawings.

FIG. 1 shows a first plug-in codification connection with an indication member of the invention in a schematic way.

FIG. 2 shows another plug-in codification connection with an indication member of the invention in a schematic way.

FIG. 3 shows a cross section through a casing for the accommodation of a plug-in codification connection and an indication member.

FIG. 4 shows a top view to an operating panel of a floor conveyor.

FIG. 5 shows a sign according to FIG. 4 in a magnified view, with the indication of the individual functions of a multifunction lever according to FIG. 4.

FIG. 6 shows the plug according to FIG. 4 together with the sign, in a perspective view.

FIG. 7 shows the connection of the sign ribbon according to FIG. 6, with a lower base of the plug according to FIG. 6.

### DETAILED DESCRIPTION

In FIG. 1, a sign 10 is depicted, which consists of a plastics plate for instance, which may be attached to a visible surface in the region of the drivers seat of a floor conveyor (not shown), by gluing or even by catching it in an opening (not shown). On its top side, the sign shows an indicating panel 12, which is either engraved into the plate or glued up by means of a sheeting. The indicating panel shows in a schematic way a load fork 14 and one arrow directed upward and one arrow directed downward. The indicating panel 12 is assigned to a not shown operational control element for a function of the not shown floor conveyor. When he/she actuates the operational control element in the direction of one of the arrows, the vehicle operator knows that the load fork 14 performs a lifting or lowering movement.

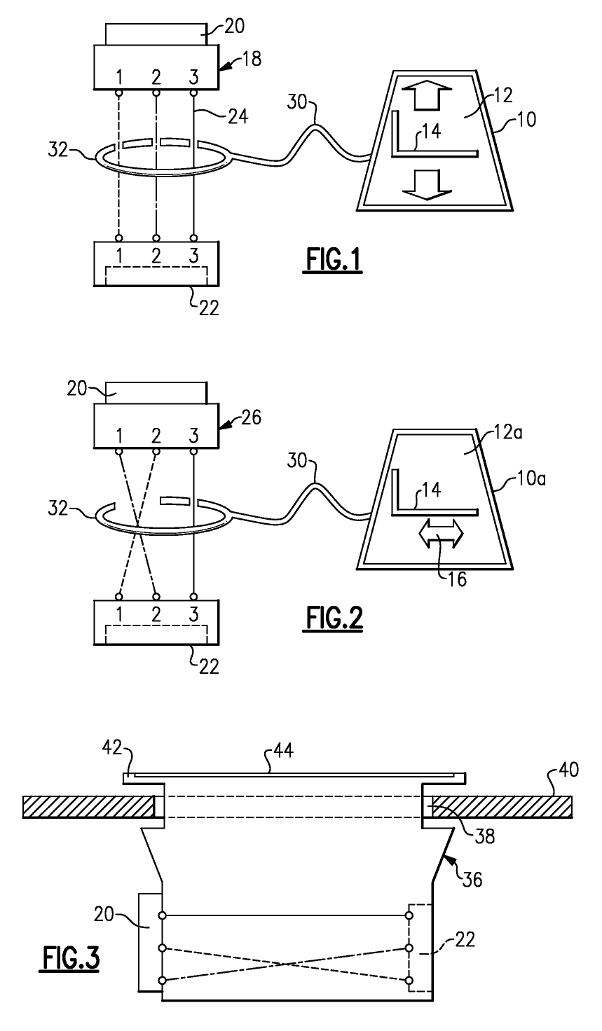

A similar sign 10a is shown in FIG. 2. A double arrow 16 is indicated with respect to the load fork 14. The arrow 16 means that an actuation of the assigned operational control element results in a shifting of the load fork 14 into the direction of the double arrow 16. Thus, the sign 10a is to be assigned to another function.

In FIG. 1, a first plug-in codification connection 18 is depicted, with a male plug part 20 and a female part 22. The pins and jacks of the parts 20, 22 are connected to each other via lines 24. The pin assignment is such that always the number 1 of the part 20 is connected to the number 1 of the part 22, and so forth.

In a plug-in codification connection 26 according to FIG. 2 with a plug part 20 and a jack part 22, the 1 of the plug part 20 is connected to the 2 of the jack part 22, for instance, and the 2 of the plug part 20 with the 1 of the jack part 22, for instance. Thus, the corresponding lines cross over each other. Therefore, when the already mentioned operational control element is connected to the not shown control unit of the floor conveyor via the codification plug 26, a shifting actuation of the load fork 14 takes place according to FIG. 2, whereas in a connection according to FIG. 1, a height movement of the load fork 14 is generated.

In both embodiments according to FIGS. 1 and 2, a ribbon 30 is envisioned, which captively winds itself around the plug-in codification connection 18 or 26, respectively, with a loop 32. For instance, the ribbon 30 may be a flat ribbon. By the arrangements according to FIG. 1 or 2, respectively, it is made sure that the correct sign 10a or 10b, respectively, is assigned to the operational control element, because the correct function of the floor conveyor is assigned to the sign 10a or 10b also, via the plug-in codification connection 18 or 26, respectively.

Instead of the loop 32, a flat piece with an opening may be provided and with such a geometry that it accommodates the plug 20 or the jack part of the codification plug 18 or 26 or the cables 24 with positive fit. By doing so, a non-detachable connection is also created.

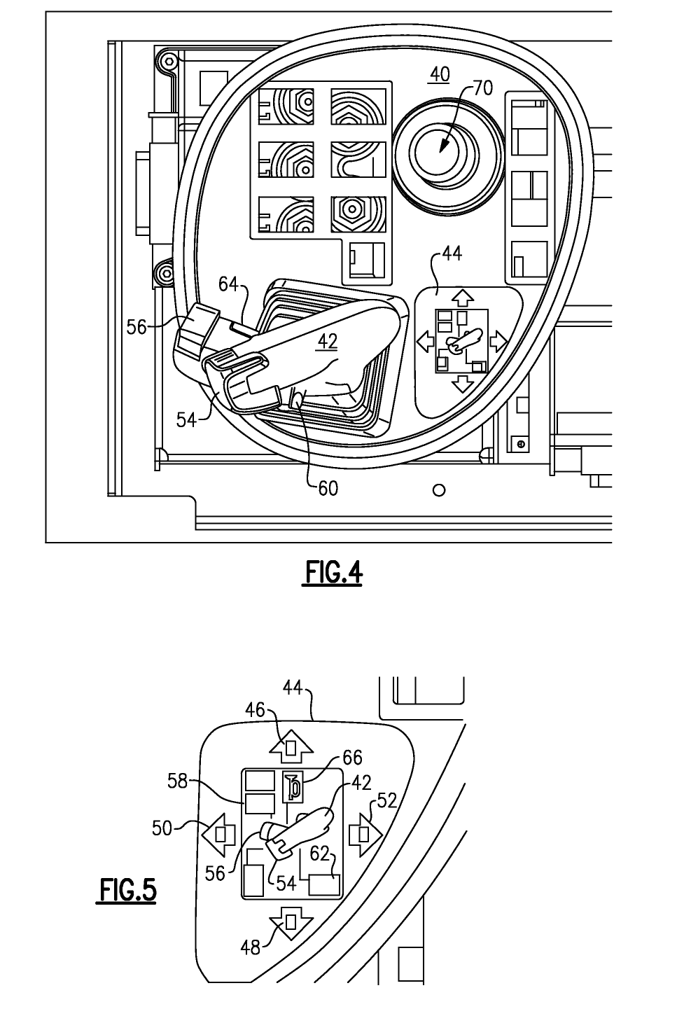

In FIG. 3, a casing 36 is depicted, which is caught in an opening 38 of an instrument panel 40 of a floor conveyor via a catch connection. The casing 36 can be removed from the opening 38 only deliberately. The casing 36 contains the plug-in codification connection 26 according to FIG. 2, as can be recognized through the lines without further problems. On its outer side, the casing 36 has a plate section 42 with a recess, in which a sign 44 is arranged in a countersunk way. The sign 44 may be a little plastics plate or even a sheeting. The sheeting or the little plate carries an indicating panel, as can be recognized by the indicating panel 12 in FIG. 1, or by the indicating panel 12a in FIG. 2.

The casing 36 can be screwed to the instrument panel 40, or it may be formed in one piece with the instrument panel 40.

In FIG. 4, an operating panel of a not shown floor conveyor is depicted, which is arranged at one side of the driver on the drivers seat. Details of the floor conveyor and also those of the driver's seat are not indicated. They are commonly known. In the operating panel 40, a multifunction lever 42 can be recognized as the main operating member. The same is also shown on a sign 44, on which the individual functions are indicated which can be operated by the multifunction lever. From this, one recognizes that the multifunction lever 42, which is grasped from the topside with the hand, can be adjusted in two orthogonal planes. In the one plane, which is indicated by the arrows 46, 48, a load carrying means, a fork for instance, is lifted or lowered, respectively. In the plane vertical to it, as indicated by arrows 50, 52, a lifting scaffold or a pantograph, respectively, is moved to and away from the vehicle when there is an adjustment in this plane.

Further, one recognizes in FIG. 4 that on the front end of the multifunction lever 42, a rotary type switch 54 is arranged. The rotary type switch 54, which is actuated with the thumb of the hand which grips the lever 42, allows the adjustment of the traveling speed of the not shown floor conveyor or of the traveling direction, respectively. Upon actuation with the forefinger, a switch 56 on the multifunction lever 42 triggers the inclination of the load carrying means or of the fork, respectively, around a horizontal axis. This is indicated in FIG. 5 on the sign at 58. However, when a button 60 on the lever 42 is pressed at the same time, the actuation of the switch 56 results in a lateral shift of the load carrying means or of the fork, respectively. This is indicated on the sign in FIG. 5 at 62. Pressing a button 64 on the multifunction switch 42 actuates a horn, as is indicated at 66 in FIG. 5.

The individual functions of the multifunction lever 42 are connected to a not shown control unit. This connection takes place via a plug 70, which is depicted in FIG. 4 and which is inserted into the panel 40. The connection of the individual lines from the multifunction lever 42 to the plug 70 and from there to the control unit is not shown. It is essential that the sign 44 is connected to the plug via a suitable ribbon or the like, as is shown in FIGS. 1 and 2. Thus, sign 44 and plug 70 form a unit, wherein the parts thereof can only be separated in that the not shown ribbon is cut through. Thus, the plug 70 forms also a plug-in codification connection, through which operational control elements of the multifunction lever and of the not shown control unit are connected, as has been explained above by means of the other figures. It is to be understood that by permutation of the lines on the plug 70, the switch 54 may be used for lifting and lowering or for shifting the lifting scaffold, for instance. In this case, even the sign has to be removed together with the plug 70, and a new sign will be non -detachably connected with the plug 70 of the new connection.

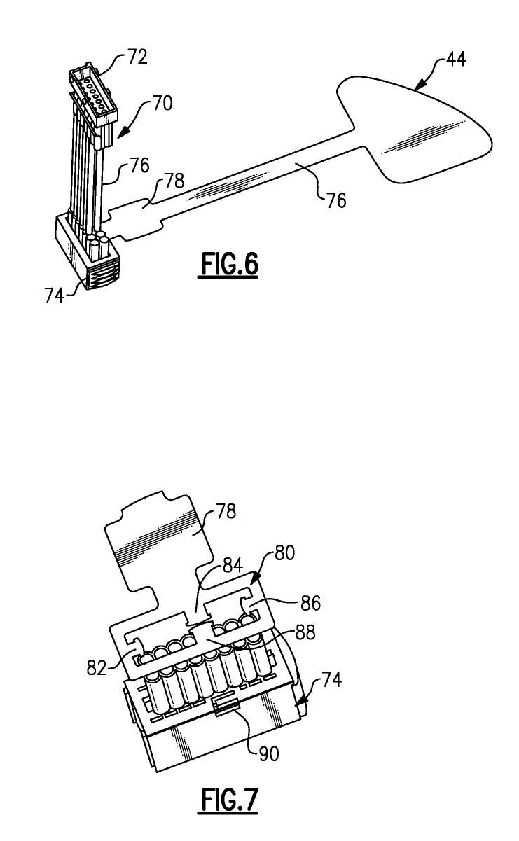

In FIG. 6, the connection plug 70 according to FIG. 4 is exposed. It has an upper base 72 and a lower base 74, which are connected with each other via lines 76. The function of such a plug 70 has been explained in more detail above. Further, the sign 44 can be recognized in FIG. 6, without the overprint according to FIGS. 4 and 5. Instead of the overprint, a suitable label may also be glued on, which features the symbols according to FIGS. 4 and 5. The sign 44 is essentially non connected with the base 24 via a flat flexible ribbon 76, which has a broadening at 78. This is indicated in FIG. 7.

In FIG. 7 one can recognize that the broadening 78, which can be provided with a warning overprint such that it is warned to remove the ribbon from the plug 70, is followed by a frame 80, which has interior projections 82, 84, 86 and 88. The frame 80 is slipped over the rectangular base 74, wherein the projection 82 to 88 engage into corresponding recesses of the base 74, only one recess 90 being perceivable in FIG. 7. The connection of the frame 80 with the base 74 is such that any release of the frame 80 from the base 74 is essentially only possible by destruction of the frame 80.

1-6. (canceled)

7. An operating device for at least two functions of a floor conveyor, said device featuring at least one manually operable operational control element for an electric switch, which is connected with an electric/electronic control unit for the functions via electric lines, wherein a plug-in codification connection is arranged in the course of the wiring of the leads, the interior connection of which pre-sets which one of the two functions is driven by the operational control element, wherein an indicating panel for the respective envisioned function is arranged on a visible surface in the floor conveyor near to the operational control element, wherein at least one of a sign and a carrier for an indicating panel is non-detachably connected with the plug-in codification connection via a connection means.

8. An operating device according to claim 7, wherein the connection means is a flat ribbon.

9. An operating device according to claim 7, wherein the plug-in codification connection is arranged on a casing, said casing being non-detachably arranged in an opening of the visible surface and having the indicating panel on an outer side.

10. An operating device according to claim 9, wherein at least one of an indicating sign and a display sheeting is attached to the casing.

11. An operating device according to claim 9, wherein said casing is made from a plastic material and forms a catching connection with the opening.

12. An operating device according to claim 7, wherein the carrier is a plate made from a plastic material, said carrier being one of attached on a visible surface, and fixed in an opening of the visible surface by catching therein.
